(19) United States
(12) Patent Application Publication
(10) Pub. No.: US 2010/0083879 A1
(43) Pub. Date: Apr. 8, 2010

(54) LOW VOC JOINT COMPOSITION

(75) Inventor: Hubert C. Francis, Lithonia, GA (US)

Correspondence Address: Georgia-Pacific LLC, 133 Peachtree Street NE - GA030-41, ATLANTA, GA, 30303, US

(73) Assignee: GEORGIA-PACIFIC GYPSUM LLC, Atlanta, GA (US)

(21) Appl. No.: 12/247,268

(22) Filed: Oct. 8, 2008

(51) Int. Cl. C04B 2/00

(52) U.S. Cl. 106/795

(57) ABSTRACT

A drying type, low VOC filler or joint composition that when mixed with water to produce a wet, paste-like mixture, can be spread easily to fill wallboard joints and other wallboard surface defects and imperfections; dries to a solid mass and can be sanded to a smooth finish.

### BACKGROUND OF THE INVENTION

1. Field of the Invention

The present invention relates to a low VOC filler or joint composition and more specifically to a low VOC filler or joint composition particularly adapted for use with wallboard, also commonly referred to as drywall, gypsum board and plaster board.

2. Description of Related Art

Wallboards (also referred to as drywall), comprising a set gypsum core sandwiched between facers of paper and coated and uncoated glass mats, are used extensively in the building industry for constructing interior walls and ceilings. An interior space is partitioned into separate rooms by affixing such wallboards to studs or other support elements in an edge-to-edge relationship and often in edge-to-edge contact.

Joints formed between such adjoining panels of wallboard are unsightly, as are the depressions associated with the heads of the screws, or nails often used to secure the wallboards to the studs. Accordingly, in those applications where the final finish of the wallboard constitutes a paint or wallpaper finish (in contrast to a plaster finish), it is desirable for aesthetic purposes to hide the joints and other surface defects or holes, so that the wall or ceiling has the appearance of a smooth, continuous and essentially flat surface.

As an aid in providing a smooth finish about the joint between adjacent wallboards, the edge portions of the wallboard panels are commonly tapered to provide, at the joint between adjoining panels, a shallow valley. This valley is filled with a soft, wet filler composition, commonly referred to as “joint compound,” “joint composition,” or possibly “spackling compound” using a trowel or similar tool. By properly filling in the space comprising the valley with joint or filler composition, allowing the composition to harden, followed by smoothly sanding the dried material, one is able to hide the joint so that the wall or ceiling has the appearance of a continuously smooth, flat surface. Typically, a fiberglass, cloth, or paper reinforcing tape material is embedded in the joint composition to reinforce the joint. One or more additional coats of the joint or filler composition are then applied in an effort to achieve the desired smooth appearance. The proper use of joint composition with taper-edged panels and reinforcing tape is an excellent way for producing a wall or ceiling which appears in all respects to be monolithic in structure.

As noted, filler or joint composition also is used to cover fasteners, usually nails, or screws, which affix a wallboard panel to its support elements. The fastener is ordinarily secured slightly below the surface of the wallboard panel, and the space, hole, or depression between the head of the fastener and the planar surface of the panel also is filled with joint composition to conceal the fastener head and impart a continuously smooth appearance to the board.

Joint or filler compositions are generally provided in two forms: as a dry powder for mixing on the job site with water to the desired consistency at the time of use, or in a ready-to-use wet paste form. Joint compositions also come as a drying type composition, or as a setting type composition. A typical ready-to-use joint composition is a water-containing, wet, coherent paste-like mass of fine-particle solids capable of being spread readily as it is worked with a tool such as a trowel, a broad blade knife and the like. Since it has a mud-like consistency, joint compound also is sometimes referred to as “mud.” In its final form, it is a hard dry solid mass of fine particle solids held together by a binder, one of the essential constituents of a joint composition. In addition to water and binder, a typical joint composition also includes a solid filler in fine particle form, and other ingredients such as a bulking agent; a water retention agent; an anti-crack agent; and a preservative.

Organic chemicals are widely used as ingredients in a variety of household products, including paints, varnishes, cleaning products and including joint compositions. For example, a variety of synthetic organic binders, such as polyvinyl acetate, polyvinyl alcohol, ethylene vinyl acetate co-polymers, vinylacrylic co-polymers, styrenebutadiene, polyacrylamides, other acrylic polymers, and other latex emulsions are typically used as a binder component in joint compositions. One potential problem with such compositions is that some of these organic chemicals have a sufficient volatility, or contain constituents with a sufficient volatility, to be emitted as gases as the product is used. These volatile components are commonly referred to as volatile organic compounds, or VOCs, and are emitted as gases from such materials. There is a continuing interest in the development of replacement products reformulated to have a reduced level of VOCs.

Thus, a key aspect of the present invention is its use of materials which result in a joint composition that is low in VOCs. This result is accomplished principally by formulating a joint composition that is substantially free of synthetic based organic binders, especially latex materials (i.e., latex emulsions).

### SUMMARY OF THE INVENTION

In one embodiment, which can be used in combination with the embodiments below, the present invention relates to a drying type, low VOC joint composition comprising a dry blend of ingredients (powder) to be mixed with water to form a paste-like composition capable of being spread readily and drying to a solid mass suitable for sanding to a smooth finish, the ingredients comprising, on a dry basis:
(1) about 70 to 96% by weight of an inorganic filler;
(2) about 2 to 10% by weight of a cross-linked starch binder;
(3) about 0.5 to 9% by weight of an expanded perlite;
(4) about 0.5 to 9% by weight of an opacifying agent;
(5) about 0.05 to 0.75% by weight of a cellulose ether; and
(6) about 0.05 to 0.3% by weight of a preservative.

In one embodiment, which can be used in combination with the embodiments above and below, the present invention relates to a drying type, low VOC joint composition comprising a dry blend of ingredients (powder) to be mixed with water to form a paste-like composition capable of being spread readily and drying to a solid mass suitable for sanding to a smooth finish, the ingredients comprising, on a dry basis:
(1) about 70 to 96% by weight of limestone filler;
(2) about 2 to 10% by weight of a crosslinked starch binder;
(3) about 0.5 to 9% by weight of an expanded perlite;
(4) about 0.5 to 9% by weight of mica;
(5) about 0.05 to 0.75% by weight of a cellulose ether; and
(6) about 0.05 to 0.3% by weight of a preservative.

In one embodiment, which can be used in combination with the embodiments above and below, the present invention relates to a drying type, low VOC ready-to-use, joint composition comprising a wet, paste-like mixture of ingredients capable of being spread readily and drying to a solid mass suitable for sanding to a smooth finish, the ingredients comprising, on a dry basis:
(1) about 70 to 96% by weight of an inorganic filler;
(2) about 2 to 10% by weight of a crosslinked starch binder;
(3) about 0.5 to 9% by weight of an expanded perlite;
(4) about 0.5 to 9% by weight of an opacifying agent;
(5) about 0.05 to 0.75% by weight of a cellulose ether; and
(6) about 0.05 to 0.3% by weight of a preservative.

In one embodiment, which can be used in combination with the embodiments above, the present invention relates to a drying type, low VOC ready-to-use, joint composition comprising a wet, paste-like mixture of ingredients capable of being spread readily and drying to a solid mass, the ingredients comprising suitable for sanding to a smooth finish, on a dry basis:
(1) about 70 to 96% by weight of limestone filler;
(2) about 2 to 10% by weight of a crosslinked starch binder;
(3) about 0.5 to 9% by weight of an expanded perlite;
(4) about 0.5 to 9% by weight of mica;
(5) about 0.05 to 0.75% by weight of a cellulose ether; and
(6) about 0.05 to 0.3% by weight of a preservative.

### DETAILED DESCRIPTION OF THE INVENTION

The present invention combines as dry ingredients: (1) about 70 to 96% by weight of an inorganic filler; (2) about 2 to 10% by weight of a crosslinked starch binder; (3) about 0.5 to 9% by weight of an expanded perlite; (4) about 0.5 to 9% by weight of an opacifying agent; (5) about 0.05 to 0.75% by weight of a cellulose ether; and (6) about 0.05 to 0.3% by weight of a preservative to produce a filler or joint composition that when mixed with water to produce a wet, paste-like mixture, can be spread easily to fill wallboard joints (e.g., the seams between adjacent wallboards) and other wallboard surface defects and imperfections; dries to a solid mass and can be sanded to a smooth finish. The filler or joint composition of the present invention is free of asbestos, free of attapulgite clay and free of synthetic laxtex materials (latex emulsions) that emit VOCs.

The present invention relates to a drying type, as opposed to a setting type, joint composition. Setting type compositions rely upon the hydration setting or curing of a component, such as calcined gypsum (Plaster of Paris) to develop hardness. The joint composition of the present invention hardens simply by drying.

In particular, the joint or filler composition of the present invention comprises a dry blend of ingredients comprising:
(1) about 70 to 96% by weight of an inorganic filler;
(2) about 2 to 10% by weight of a crosslinked starch binder;
(3) about 0.5 to 9% by weight of an expanded perlite;
(4) about 0.5 to 9% by weight of an opacifying agent;
(5) about 0.05 to 0.75% by weight of a cellulose ether; and
(6) about 0.05 to 0.3% by weight of a preservative.
   which, when mixed with an appropriate amount of water, forms a paste-like composition capable of being spread readily and drying to a solid mass that can be sanded to a smooth finish.

The joint or filler composition of the present invention is substantially VOC free. The elimination of VOCs is accomplished by using a natural binder of starch in lieu of any of the commonly employed synthetic based organic binders, especially latex materials. In other words, the joint composition of the present invention is formulated so that it is substantially free of synthetically based organic binders, especially latex materials (i.e., is substantially free of latex). As a result, the composition is environmentally friendly.

The joint or filler composition of the present invention also is free of asbestos and attapulgite clay.

The major component of the joint composition of the present invention, as least in the percent by weight thereof, is the inorganic filler. The inorganic filler is present in an amount of about 70 to 96% by weight of the dry solids of the joint composition. Usually, the inorganic filler is present in an amount of about 85 to 96% by weight of the dry solids of the joint composition. Examples of suitable inorganic fillers useful in the present invention are particulate limestone, i.e., ground or precipitated limestone (calcium carbonate), calcium sulfate dihydrate (e.g., gypsum) or a combination thereof. Based on it availability and low cost, particulate limestone is usually the inorganic filler of choice.

The filler is provided in a finely divided particulate form. The inorganic filler should have a particle size such that at least about 95% by weight and usually all of the filler particles pass through a 100 mesh wire screen. In a preferred particulate limestone inorganic filler, no more than 90% and usually no more than 80% of the particles pass through a 325 mesh screen.

The binder of choice for the joint composition of the present invention is a cross-linked starch. The crosslinked starch binder constitutes about 2 to 10% by weight of the dry solids of the joint composition. Usually, the crosslinked starch binder constitutes about 3 to 8% by weight of the dry solids of the joint composition. Useful starches are well known to those skilled in the art and include those derived from corn, potatoes, tapioca or rice. Starches can have low or high amylose content and are modified for use in the present invention by treatment with a crosslinking agent. Numerous methods for crosslinking starch are known in the art, and numerous crosslinking agents, such as sodium trimetaphosphate, epichlorohydrin, phosphorous oxychloride, and dimethyl urea, are known. The amount of crosslinker used to prepare the crosslinked starch will vary between different starches but, in general, should be used in an amount such as to allow the starch granules to swell when mixed with water, and to maintain their swollen state without dissolving or pasting out. A suitable crosslinked potato starch can be obtained y the reaction of potato starch and a phosphorus oxychloride, although urea-formaldehyde and other compounds having at least two groups which react with hydroxymethyl groups on the glucopyranose units of the starch, may be used in place of phosphorus oxychloride.

One low amylose crosslinked potato starch is commercially available from National Starch and Chemical Corp. Another suitable crosslinked starch is a cold water soluble, hydroxypropylated, cross-linked waxy corn starch available from Tate & Lyle PLC as STAR*POL 136 (formerly known as Sta-Gel 136 from A.E. Staley).

Expanded perlite is present in the mixture of ingredients used to produce the joint composition of the present invention in an amount of about 0.5 to 9 weight percent based on the dry weight of the other ingredients, usually in an amount of about 1 to 5 weight percent. Expanded perlite is available in various forms as is well known to those of ordinary skill in the art.

Speaking generally, expanded perlite can be formed by heating moisture-containing, natural-occurring perlite ore at a temperature within the range of about 1,500° to 2,000° F. (815° to 1093° C.) Such heat treatment explodes or expands the perlite to, for example, 15-20 times its original volume forming a light fluffy material similar to pumice. Commercially available forms of expanded perlite known as cryogenic, plaster and concrete aggregate are exemplary of materials that can be used in the practice of the present invention.

For use in the present invention, the expanded perlite should be treated to render it water-resistant. The prior art has described a number of different ways for accomplishing this result. The present invention is not to be limited to any particular technique for treating the expanded perlite in order to make it suitable for use as a component of the joint composition. One known method is to treat the expanded perlite with a silicone compound which seals cracks and fissures. A suitable silicone compound is a water-dilutable emulsion of a polydimethyl siloxane. Another material described in the prior art is an aminofunctional siloxane or silicone polymer, formed as a mixture or copolymer of an aminosilane and an alkyl-substituted silane such as a methyl containing silane. The silicone compound can be applied to the expanded perlite by spraying or immersion and then cured as needed.

Expanded perlite, suitable for use in the present invention, generally has a density before any surface treatment of from about 2 to about 11 lbs per cubic foot (pcf). Usually, an expanded perlite with a pretreatment density of about 4 to 8 pcf will be used, such as a 6.5 pcf perlite. Furthermore, the particle size of the expanded perlite can vary over a wide range. Generally an expanded perlite having a particle size distribution that passes through a 100 mesh screen and even through a 200 mesh screen (U.S. Standard Sieve Series) should be suitable. Other suitable size distributions can be readily determined by skilled workers using routine testing.

The expanded perlite adds bulk to the composition and functions as a light weight filler that improves the efficiency of the starch binder and thus allows the composition to have less binder and more filler constituents. Best results should be obtained using those forms of expanded perlite which are more resistant to being compressed or compacted. It has been observed that various forms of perlite are less spongy than others. The less spongy the perlite, the greater its resistance to being compressed. Conversely, the more spongy the perlite, the more readily it is compressed. See U.S. Pat. No. 4,159,302 for additional discussion.

The joint composition of the present invention also includes an additive designed to enhance the opacity or opaqueness of the dried paste-like material as the joint composition hardens. Referred to as an opacifying agent, minerals having a lamellar form such as mica, kaolin clay or talc are generally considered to be suitable. The opacifying agent, and particularly mica, is included in the joint composition in an amount of 0.5 to 9% by weight of the dry ingredients, usually in an amount of 1 to 5 percent by weight.

In part to facilitate the mixing of the dry ingredient and also because of its property as a thickener, the joint composition of the present invention also includes a nonionic cellulose ether in an amount of about 0.05 to 0.75% by weight of the other dry ingredients, usually in an amount of about 0.075 to 0.5 percent by weight. Cellulose ethers useful in this invention are the products of the etherification of cellulose with a variety of etherifying agents. Cellulose is a naturally occurring, high polymeric carbohydrate composed of anhydro-glucose units. Cellulose is etherified by the reaction of the free hydroxyl groups of the anhydro-glucose units with etherifying agents. The common etherifying agents useful to prepare a cellulose ether are alkyl halides and alkylene oxides.

Such nonionic cellulose ethers may include methylcellulose, ethylcellulose, hydroxymethylcellulose, hydroxyethylcellulose, carboxymethylcellulose, carboxyethylcellulose, hydroxypropylcellulose, hydroxypropyl methyl cellulose, benzyl hydroxyethyl cellulose and phenyl hydroxyethyl cellulose, and mixtures thereof. Such water-soluble cellulose ethers may exhibit a viscosity of 1,500 cps to 100,000 cps and often between 6,000 cps to 20,000 cps, in 2% by weight aqueous solution and measured at 250 C., but viscosities outside these ranges are suitable in certain applications.

A particularly suitable cellulose ether for use in the present joint composition is Methocel® 240 (or 240S) cellulose ether (believed to be a hydroxypropyl methylcelluose (HPMC)) available from the Dow Chemical Company. Other cellulose ethers such as hydroxyethyl cellulose once available under the trade name “Cellosize” from Union Carbide Corporation; “Tylose” from American Hoechst; “Klucel” from Hercules Corporation; and benzyl hydroxyethyl or phenyl hydroxyethyl cellulose ethers from Hercules Chemical Co. may also be suitable depending on the particular formulation of the joint composition.

In addition to providing lubricity to facilitate a thorough mixing of the dry ingredients of the joint composition of the present invention, the cellulose ether component also improves the workability and consistency of the slurry or paste obtained by incorporating water into the dry composition making spreading easier and increasing efficiency. The cellulose ether also increases water retention which prolongs working time and facilitates proper application of the wet mixture. By providing a desirable effect on the drying rate of the paste or slurry, the cellulose ether also helps to minimize the formation of cracks in the dried composition.

The final, solids-containing constituent required for use in the joint composition of the present invention is a preservative such as a mildecide or a fungicide. A preservative is preferably included in the composition in an amount of about 0.05 to 0.3% by weight of the dry ingredients of the joint composition. The inclusion of this ingredient in the composition ensures the long term stability of the composition, notwithstanding the inclusion of both a cellulose ether and the starch binder in the mixture, by retarding or preventing the growth of bacteria and/or fungus. Suitable preservatives for use in the composition of the present invention will be apparent to those skilled in the art and include preservatives available under the Mergal® and Polyphase® lines of preservatives available from Troy Corporation. Another suitable preservative is Vancide® MZ 96 available from the R.T. Vanderbilt Company, Inc. Some of these antimicrobial preservatives are supplied in a solid form while others are available as liquids. For preparing a dry mix, the solid forms of a preservative will usually be used. Nonetheless, given the low level at which the preservative is included in the composition, the state in which it is supplied does not prevent the preparation of the overall composition as a dry blend of solids or powder.

Finally, water is an essential ingredient of the joint or filler composition of the present invention, but when it is combined with the other ingredients depends on whether the composition is of the ready-to-use type or the dry powdery type. An amount of water should usually be added to the dry mixture of ingredient such that the viscosity of the resulting paste-like composition is within the range of about 350 to about 750 Brabender units at 70° F. (21° C.), and usually within the range of about 500 to about 600 Brabender units at 70° F. (21° C.). Skilled workers understand that for any particular formulation, the amount of water needed to obtain a suitable working viscosity will tend to vary somewhat, depending on the particular ingredients and their relative proportions.

As understood by those skilled in the art, joint or filler compositions may also contain other materials designed to improve or impart certain desired properties to the basic composition. Examples of such materials are: additional thickening agents; water-retention agents; surface active agents; and crack-reducing agents. Such materials function to improve performance, workability or stability properties of the composition.

Ready-to-use formulations or compositions in the dry powdery form can be prepared using the various ingredients in the proportions noted above, but it should be appreciated that, depending on whether the composition is of the ready-to-use type or the dry powdery type, and depending upon the particular ingredients used, some adjustments may be necessary within the stated ranges to maximize desired properties.

The following non-limiting example further illustrates the invention.

### EXAMPLE

A dry blend of ingredients suitable for mixing with water to produce a ready-to-use joint composition:

| | Amount (dry |
|---|---|
| Ingredients | weight percent) |
| Limestone - | 92.9 |
| MicroWhite 100 | |
| from Imerys | |
| Crosslinked Starch Binder | 3.6 |
| STAR*POL ® 136 Starch | |
| from Tate & Lyle PLC | |
| Mica | 1.6 |
| 4-K | |
| from Kings Mountain Minerals | |
| (formerly Oglebay Norton Specialty) | |
| Expanded Perlite | 1.6 |
| Sil-Cell ® 35-34 | |
| From Silbrico Corp. | |
| Cellulose Ether | 0.1 |
| Hydroxypropylmethyl cellulose | |
| Methocel ® 240 | |
| From The Dow Chemical Company | |
| Preservative | 0.2 |
| Mergal ® 174 | |
| From Troy Corporation | |

The dry blend of ingredients are mixed with water in an amount of at least about 50 parts per 100 parts total solids to produce a paste of a suitable viscosity for use as a ready-to-use joint composition.

The present invention has been described with reference to specific embodiments for the purpose of describing, but not limiting the invention. Various modifications, which will become apparent to one skilled in the art, and the invention is intended to cover those changes and substitutions that may be made by those skilled in the art without departing from the spirit and the scope of the invention. Unless otherwise specifically indicated, all percentages are by weight. Throughout the specification and in the claims the term “about” is intended to encompass + or −5% and preferably is only about + or −2%

1. A drying type joint composition that is low in VOC by being substantially free of synthetic organic binders including latex emulsions comprising a dry blend of ingredients to be mixed with water to form a paste-like composition capable of being spread readily and drying to a solid mass suitable for sanding to a smooth finish, the ingredients comprising, on a dry basis:
(1) about 70 to 96% by weight of an inorganic filler;
(2) about 2 to 10% by weight of a cross-linked starch binder;
(3) about 0.5 to 9% by weight of an expanded perlite;
(4) about 0.5 to 9% by weight of an opacifying agent;
(5) about 0.05 to 0.75% by weight of a cellulose ether; and
(6) about 0.05 to 0.3% by weight of a preservative.

2. The drying type joint composition of claim 1 wherein the ingredients comprise, on a dry basis:
(1) about 70 to 96% by weight of limestone filler;
(2) about 2 to 10% by weight of a crosslinked starch binder;
(3) about 0.5 to 9% by weight of an expanded perlite;
(4) about 0.5 to 9% by weight of mica;
(5) about 0.05 to 0.75% by weight of a cellulose ether; and
(6) about 0.05 to 0.3% by weight of a preservative.

3. A drying type ready-to-use, joint composition that is low in VOC by being substantially free of synthetic organic binders including latex emulsions comprising a wet mixture of ingredients with water capable of being spread readily and drying to a solid mass suitable for sanding to a smooth finish, the ingredients comprising, on a dry basis:
(1) about 70 to 96% by weight of an inorganic filler;
(2) about 2 to 10% by weight of a crosslinked starch binder;
(3) about 0.5 to 9% by weight of an expanded perlite;
(4) about 0.5 to 9% by weight of an opacifying agent;
(5) about 0.05 to 0.75% by weight of a cellulose ether; and
(6) about 0.05 to 0.3% by weight of a preservative.

4. The drying type ready-to-use, joint composition of claim 3 comprising, on a dry basis:
(1) about 70 to 96% by weight of limestone filler;
(2) about 2 to 10% by weight of a crosslinked starch binder;
(3) about 0.5 to 9% by weight of an expanded perlite;
(4) about 0.5 to 9% by weight of mica;
(5) about 0.05 to 0.75% by weight of a cellulose ether; and
(6) about 0.05 to 0.3% by weight of a preservative.

5. (canceled)

6. (canceled)
